(19) United States
(12) Patent Application Publication
(10) Pub. No.: US 2011/0257964 A1
(43) Pub. Date: Oct. 20, 2011

(54) Minimizing Speech Delay in Communication Devices

(76) Inventors: Béla Rathonyi, Lomma (SE); Jan Fex, Lund (SE)

(21) Appl. No.: 12/860,410

(22) Filed: Aug. 20, 2010

Related U.S. Application Data
(60) Provisional application No. 61/324,956, filed on Apr. 16, 2010.

(51) Int. Cl. G10L 21/00

(52) U.S. Cl. 704/201; 704/E21.001

(57) ABSTRACT

Methods and apparatus for coordinating audio data processing and network communication processing in a communication device. In an exemplary method lower and upper threshold values for use by a network communication processing circuit are set, the lower and upper threshold values defining a window of timing offsets relative to each of a series of periodic network communications frame boundaries. A series of encoded audio data frames are sent to the network communication processing circuit for transmission over the network communications link. The delivery of encoded audio data to the network communication processing circuit outside of the corresponding time window defined by the threshold values will trigger an event report. This event report is received from the network communication processing circuit by the audio data processing circuit, and, in response, timing is adjusted for the sending of one or more of the encoded audio data frames.

### RELATED APPLICATIONS

This application claims priority under 35 U.S.C. §119(e) to Provisional Patent Application Ser. No. 61/324,956, titled “Minimizing Speech Delay in Communication Devices” and filed 16 Apr. 2010. The entire contents of the foregoing application are incorporated herein by reference. This application is related to co-pending U.S. patent application Ser. No. 12/858,670 filed 18 Aug. 2010 and also titled “Minimizing Speech Delay in Communication Devices.”

### TECHNICAL FIELD

The present invention relates generally to communication devices and relates in particular to methods and apparatus for coordinating audio data processing and network communication processing in such devices.

### BACKGROUND

When a speech call is performed over a cellular network, the speech data that is transferred is typically coded into audio frames according to a voice coding algorithm such as one of the coding modes of the Adaptive Multi-Rate (AMR) codec or the Wideband AMR (AMR-WB) codec, the GSM Enhanced Full Rate (EFR) algorithm, or the like. As a result, each of the resulting communication frames transmitted over the wireless link can be seen as a data packet containing a highly compressed representation of the audio for a given time interval.

FIG. 1 provides a simplified schematic diagram of those functional elements of a conventional cellular phone 100 that are generally involved in a speech call, including microphone 50, speaker 60, modem circuits 110, and audio circuits 150. Here, the audio that comes in from microphone 50 is pre-processed in audio pre-processing circuits 180 (which may include, for example, filtering, digital sampling, echo cancellation, or the like) and then encoded into an audio frame by audio encoder 160, which may implement, for example, a standards-based encoding algorithm such as one of the AMR coding modes. The encoded audio frame is then passed to the transmitter (TX) baseband processing circuit 130, which typically performs various standards-based processing tasks (e.g., ciphering, channel coding, multiplexing, modulation, and the like) before transmitting the encoded audio data to a cellular base station via radio frequency (RF) front-end circuits 120. For audio received from the cellular base station, the modem circuits 110 receive the radio signal from the base station via the RF front-end circuits 120, and demodulate and decode the received signals with receiver (RX) baseband processing circuits 140. The resulting communication frame is then processed by audio decoder 170 and audio post-processing circuits 190, and the resulting signal is passed to the loud speaker 60.

An audio frame typically corresponds to a fixed time interval, such as 20 milliseconds. (Audio frames are transmitted and received on average every 20 milliseconds for all voice call scenarios defined in current versions of the WCDMA and GSM specifications). This means that audio circuits 150 produce one encoded audio frame and consume another every 20 milliseconds, on average, assuming a bi-directional audio link. Typically, these encoded audio frames are transmitted to and received from the communication network at the same rate, although not always—in some cases, for example, two encoded audio frames might be combined to form a single communication frame for transmission over the radio link. In addition, the timing references used to drive the modem circuitry and the audio circuitry may differ, in some situations, in which case a synchronization technique may be needed keep the average rates the same, thus avoiding overflow or underflow of buffers. Several such synchronization techniques are disclosed in U.S. Patent Application Publications 2009/0135976 A1 and 2006/0285557 A1, by Ramakrishnan et al. and Anderton et al., respectively. The timing relationship between transmission and reception of the communication frames is generally not fixed, at least at the cellular phone end of the link.

The audio and radio processing pictured in FIG. 1 contribute delays in both directions of audio data transmission—i.e., from the microphone to the remote base station as well as from the remote base station to the speaker. Reducing these delays is an important objective of communications network and device designers.

### SUMMARY

Methods and apparatus for coordinating audio data processing and network communication processing in a communication device are disclosed. Using the disclosed techniques, synchronization between audio processing timing and network frame timing can be achieved in such a manner that end-to-end delay is reduced and audio discontinuities are avoided.

In an exemplary method for use in coordinating audio data processing and network communication processing of outbound audio data (e.g., uplink data in a mobile phone), lower and upper threshold values for use by a network communication processing circuit are set, the lower and upper threshold values defining a window of timing offsets relative to each of a series of periodic network communications frame boundaries. In the case of a radio communication device like a cellular phone, these network communications frame boundaries comprise radio frame boundaries. In some embodiments, these upper and lower threshold values are established upon initializing the device, while in others the threshold values may be established at call set-up or even during a call, by sending the lower and upper threshold values to the network communication processing circuit.

Further, a series of encoded audio data frames are sent to the network communication processing circuit for transmission over the network communications link. The delivery of encoded audio data to the network communication processing circuit outside of the corresponding time window defined by the threshold values will trigger an event report. This event report is received from the network communication processing circuit by control circuitry in or associated with the audio data processing circuit, and, in response, timing is adjusted for the sending of one or more of the encoded audio data frames. In some embodiments, this adjusting of timing comprises adjusting an audio sampling interval timing or an audio encoding interval timing, or both.

In some embodiments, the event report comprises an indication of whether the corresponding encoded audio frame was received early or late, relative to the window, or an indication of how early or how late the corresponding encoded audio frame was received, or both. In these and other embodiments, one or more event reports may indicate that an encoded audio frame was discarded by the network communication processing circuit and not transmitted.

A related technique for use in processing inbound speech data (e.g., the downlink in a mobile phone) begins with demodulating a series of received communication frames, using a network communication processing circuit, to produce received encoded audio frames. An event report for each of one or more of the received encoded audio frames is generated, the event report indicating a network communication circuit processing time associated with the corresponding received encoded audio frames. The received encoded audio frames are decoded, using an audio data processing circuit, and the decoded audio is output to an audio circuit (e.g., a loudspeaker). Finally, the timing of the outputting of the decoded audio is adjusted, based on the generated event reports.

Communication devices containing one or more processing circuits configured to carry out the above-summarized techniques and variants thereof are also disclosed. Of course, those skilled in the art will appreciate that the present invention is not limited to the above features, advantages, contexts or examples, and will recognize additional features and advantages upon reading the following detailed description and upon viewing the accompanying drawings.

### BRIEF DESCRIPTION OF THE DRAWINGS

FIG. 1 is a block diagram of a cellular telephone.

FIG. 2 illustrates audio processing timing related to network processing and frame timing in a communications network.

FIG. 3 is a block diagram of elements of an exemplary communication device according to some embodiments of the invention.

FIG. 4 illustrates an exemplary signal flow between an audio processing circuit and a modem circuit.

FIG. 5 illustrates another exemplary signal flow between an audio processing circuit and a modem circuit.

FIG. 6 is a process flow diagram illustrating an exemplary method for coordinating audio data processing and network communication processing in a communication device.

FIG. 7 is a process flow diagram illustrating another exemplary method for coordinating audio data processing and network communication processing in a communication device.

### DETAILED DESCRIPTION

In the discussion that follows, several embodiments of the present invention are described herein with respect to techniques employed in a cellular telephone operating in a wireless communication network. However, the invention is not so limited, and the inventive concepts disclosed and claimed herein may be advantageously applied in other contexts as well, including, for example, a wireless base station, or even in wired communication systems. Of course, the detailed design of cellular telephones, wireless base stations, and other communication devices may vary according to the relevant standards and/or according to cost-performance tradeoffs specific to a given manufacturer, but the basics of these detailed designs are well known. Accordingly, those details that are unnecessary to a full understanding of the present invention are omitted from the present discussion.

Furthermore, it will be appreciated that the use of the term “exemplary” is used herein to mean “illustrative,” or “serving as an example,” and is not intended to imply that a particular embodiment is preferred over another or that a particular feature is essential to the present invention. Likewise, the terms “first” and “second,” and similar terms, are used simply to distinguish one particular instance of an item or feature from another, and do not indicate a particular order or arrangement, unless the context clearly indicates otherwise.

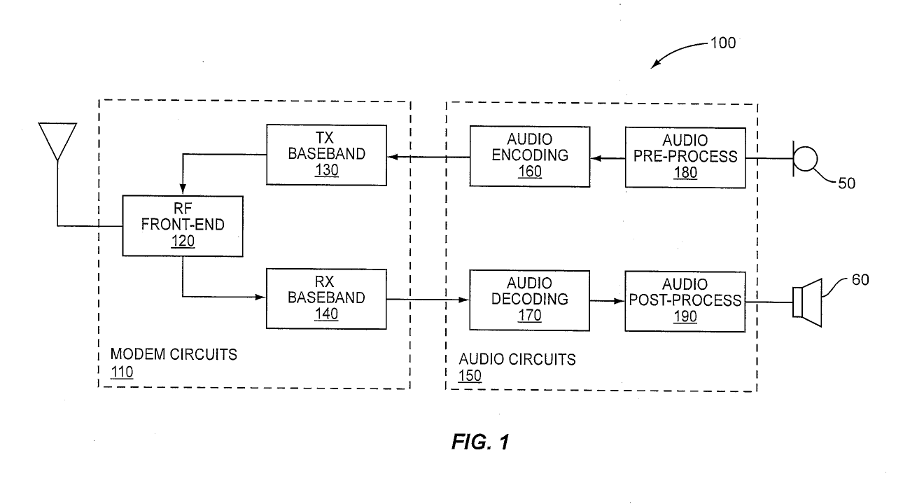

As was noted above with respect to FIG. 1, the modem circuits and audio circuits of a cellular telephone (or Other communications transceiver) introduce delays in the audio path between the microphone at one end of a communication link and the speaker at the other end. Of the total round-trip delay in a bi-directional link, the delay introduced by a cellular phone includes the time from when a given communication frame is received from the network until the audio contained in that frame is reproduced on the loudspeaker, as well as the time from when audio from the microphone is sampled until that sampled audio data is encoded and transmitted over the network. Additional delays may be introduced at other points along the overall link as well, so minimizing the delays introduced at a particular node can be quite important.

Although FIG. 1 illustrates completely distinct modem circuits 110 and audio circuits 150, the separation need not be a true physical separation. In some devices, for example, some or all of the audio encoding and decoding processes may be implemented on the same application-specific integrated circuit (ASIC) used for TX and RX baseband processing functions. In others, however, the baseband signal processing may reside in a modem chip (or chipset), while the audio processing resides in a separate application-specific chip. In some cases, regardless of whether the audio processing and baseband signal processing are on the same chip or chipset, the audio processing functions and radio functions may be driven by timing signals derived from a common reference clock. In others, these functions may be driven by separate clocks.

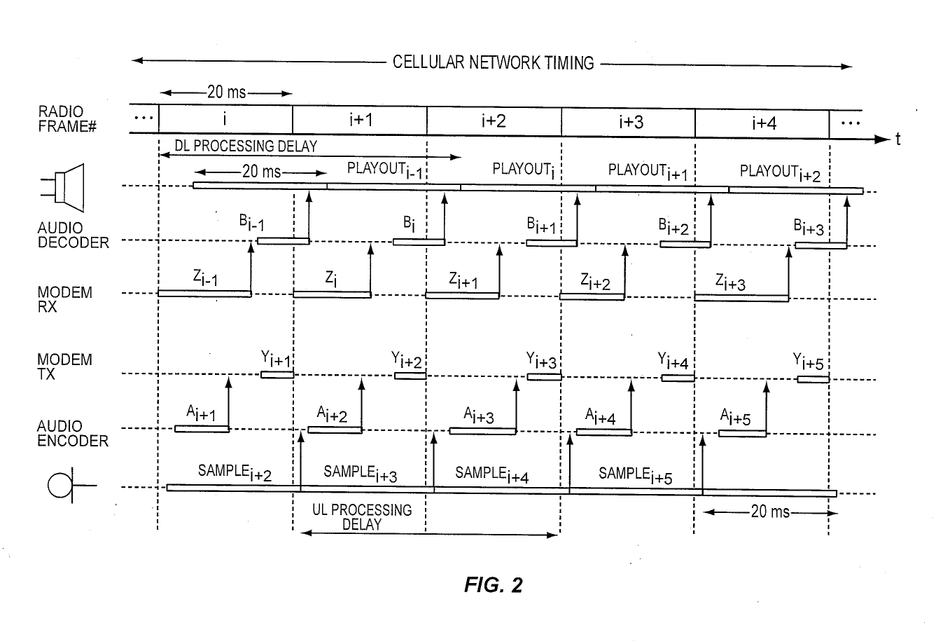

FIG. 2 illustrates how the processing times of the audio processing circuits and modem circuits relate to the network timing (i.e., the timing of a communications frame as “seen” by the antenna) during a speech call. For simplicity, it is assumed that the radio frame timing is exactly the same in both directions of the radio communications link. Of course, this is generally not the case, but this assumption makes the illustration easier to understand and has no impact on the operation of the invention.

In FIG. 2, each radio frame is numbered with i, i+1, i+2, and the corresponding audio sampling, playback, encoding, and decoding processes, as well as the corresponding radio processes, are referenced with corresponding indexes. Thus, for example, it can be seen at the bottom of the figure that for radio frame i+2, audio data to be transmitted over the air interface is first sampled from the microphone over a 20 millisecond interval denoted Sampleᵢ₊₂. An arrow at the end of that interval indicates when the speech data (often in the form of Pulse-Code Modulated data) is available for speech encoding. In the next step (moving up, in FIG. 2) it is processed by the audio encoder during a processing time interval denoted Aᵢ₊₂. An arrow at the end of this interval indicates that the encoded audio frame can then be sent immediately to the transmitter processing portion of the modem circuit, which performs its processing during a time interval denoted Yᵢ₊₂. The modem processing time interval Yᵢ₊₂ does not need to immediately follow the audio encoding time interval Aᵢ₊₂. This is because the modem processing interval is tied to the transmission time for radio frame i+2, rather than being coupled directly to the audio processing; this will be discussed in further detail below.

The rest of FIG. 2 illustrates the timing for processing received audio frames, in a similar manner. The modem processing time interval for a received radio frame k is denoted Zₖ while the audio processing time is denoted Bₖ. The interval during which the received audio data is reproduced on the speaker is denoted Playoutₖ.

The Playoutₖ and Sampleₖ intervals must generally start at a fixed rate to sample and playback a continuous audio streams for the speech call. In the exemplary system described by FIG. 2, these intervals recur every 20 milliseconds. However, the various processing times discussed above (Aₖ, Bₖ, Yₖ, and Zₖ) may vary during a speech call, depending on such factors as the content of the speech signal, the quality of the received radio signal, the channel coding and speech coding used, the number and types of other processing tasks being concurrently performed by the processing circuitry, and so on. Thus, there will generally be jitter in the timing of the delivery of the audio frames between the audio processing and modem entities.

Because of the sequential nature of the processing, several relationships apply among the various processing times. First, for inbound processing, the start of the modem receive processing interval (Zₖ) is dictated by the cellular network timing (i.e., by the radio frame timing at the receive antenna) and is outside the control of the cellular telephone. Second, the start of the audio playback interval Playoutₖ, relative to the radio frame timing, should be set no earlier than the maximum possible duration of the modem receive processing interval Zₖ plus the maximum possible duration of the audio processing interval Bₖ, in order to ensure that decoded audio data is always available to be sent to the speaker.

For the outbound processing, the modem transmit processing interval Yₖ must end no later than the beginning of the corresponding radio frame. Thus, the latest start of the modem transmit processing interval Yₖ is driven by the radio frame timing and the maximum possible time duration of Yₖ. This means that the corresponding audio processing interval Aₖ should start early enough to ensure that is completed, under worst case conditions, prior to this latest start time for the modem transmit processing interval. Accordingly, the optimal start of the audio sampling interval Sampleₖ, relative to the frame time, is given by the maximum time duration of Yₖ+Aₖ in order to ensure that an encoded audio frame is always available to be sent over the cellular network.

For good end-to-end audio quality in a conversational speech call, delays should be kept as small as possible. Accordingly, it is beneficial to synchronize each of the audio encoding and decoding processes with the corresponding uplink and downlink cellular network timing in such a way that reduces this delay. In the event that the audio processes are not synchronized with the communication frame timing in this manner (e.g., in the event that the audio processing timing is arbitrarily established, relative to the communication frame timing), the delay introduced in addition to the processing times Aₖ, Bₖ, Yₖ, and Zₖ would then vary between 0 and 20 milliseconds in each direction (with a mean value of 10 milliseconds). The reason for this is that both the sampling of the audio frames from the microphone and the playback of the audio data from received audio frames on the speaker must be at a fixed repetition rate and performed each 20 milliseconds, in order to avoid gaps in the audio stream. If, for example, the sampling is begun such that the subsequent speech encoding is completed 12 milliseconds before processing time Yₖ must start, then a constant (and unnecessary) delay of 12 milliseconds is introduced.

Worse, if the timing selected for sampling the audio or playback of the audio is too close to the corresponding communication frame timing, situations may arise where a given audio frame is occasionally too late, due to the variability of the processing times. In the case of the outbound (uplink, in the case of the cellular phone) a gap of 20 milliseconds in the audio stream will result. Two scenarios are then possible. In the first, the late audio frame is kept and transmitted at the next communication frame interval, in which case an additional 20 milliseconds delay is introduced for the rest of the call. In the second, the late audio frame is discarded, in which case the remote end of the link must deal with the 20 millisecond gap introduced each time an audio frame is late.

To introduce as little end-to-end delay as possible the total processing times should be kept as small as possible. Furthermore, the time between finishing the processing in one processing unit (e.g., an audio processing unit) and starting at the next (e.g., a radio modem) should be kept as small as practical. Of course, some margin should be provided to account for small jitters in the processing times, as well as to provide any necessary time for transferring data between different sub-systems (e.g., between processing units using different CPUs and memories). However, systematic time intervals during which the data is simply waiting for the next processing step should be minimized.

Accordingly, when designing a cellular phone or other communications transceiver that supports speech communications, techniques for determining the best start times for audio sampling processes and audio playout processes, as well as the best start times for audio encoding and decoding processes, are important. In other words, referring once more to the exemplary scenario of FIG. 2, the start of the processing intervals Aₖ and Bₖ should be carefully selected so that the end-to-end delay is kept low (to get good audio quality) and to ensure that no time gap (or interruption time) is present in either direction of the audio flow. Of course, as discussed above, these start times must be selected based on the various processing times for the particular equipment, as well as on the cellular network timing. Because these processing times as well as the network timing can change during the speech call (e.g., as the result of a handover between cellular technologies such as GSM and WCDMA), some speech interruption times may be unavoidable. Even in these situations, however, the techniques described herein may be used to keep these interruptions as short as possible. In particular, as will be described in more detail below, these techniques may be used to change the synchronization between audio processes and network timing, in response to such changes in the system timing or in processing times, to keep the end-to-end delays as short as possible.

To put the techniques of the present invention in perspective, a review of alternative approaches to the problem described herein may be useful. One possible approach to determining the start time of the audio sampling and audio playout, relative to the cellular network frame timing, is based on determining in advance the maximum possible time duration for each of the processing times in the chain. Thus, for example, the maximums for each of the processing intervals Aₖ, Bₖ, Yₖ, and Zₖ, as discussed above with respect to FIG. 2, are determined. Then, frame timing can effectively be transferred from the modem circuitry to the audio processing circuitry by sending continuous events (e.g., synchronous pulses) from the modem circuit to the audio processing circuit. In other words, timing between the modem circuit and the audio processing circuit is synchronized, using a dedicated synchronization signal. Given an accurate synchronization signal, it becomes straightforward to calculate backwards to determine when to start the sampling processing, or to calculate forwards to determine the playout timing, based on the maximum processing durations. If it is assumed that the timing event jitter is zero (i.e., perfect synchronization between the modem and audio processing circuits), and if it is further assumed that both the uplink and downlink are synchronized in time (again, a simplifying assumption only), then if the synchronization event is sent precisely at the radio frame boundary then the audio sampling process should be initiated at exactly Aₖ₋ₘₐₓ+Yₖ₋ₘₐₓ milliseconds before the synchronization timing event, where Aₖ₋ₘₐₓ and Yₖ₋ₘₐₓ are the maximum outbound audio processing and modem processing times, respectively. Similarly, the playout for each audio frame should be scheduled for exactly Bₖ₋ₘₐₓ+Zₖ₋ₘₐₓ milliseconds after the synchronization event for the corresponding radio frame.

Variants of this approach are used today in some GSM and WCDMA systems, where timing signals are generated every 20 ms to trigger speech encoding/decoding activities. However, a drawback of this approach is that the time must be accurately synchronized between the modem circuits and the audio processing circuits of a cellular phone. This is possible today in devices where these two parts are tightly integrated. However, in some devices the modem processing and audio processing may be carried out on separate hardware subsystems, making it more difficult and more expensive to achieve accurate time synchronization between the two processing units. To minimize signaling between the two units, communication between the two parts could be limited to a signal/message-based communication channel where the transport of the signals/messages jitters in time. While this communication channel could be used to send a time synchronization message periodically, it may be difficult to get an accurate time transfer due to jitter. The result is that larger timing margins must be utilized, to account for this increased jitter, with the consequence of greater end-to-end delays. Furthermore, this jitter, as well as the maximum processing times of the modem circuit and the audio circuit, may not remain the same throughout the lifetime of a speech call, and could change depending on what parallel processes are currently being managed by the modem and audio circuitries. Thus, it may be quite difficult to minimize the additional delay not related to the actual processing steps a system using this approach.

A simpler approach is to simply ignore the network timing, and simply fix the sample/encoding and decoding/playout to an arbitrary start time, repeated every 20 milliseconds. As suggested above, however, this approach has the drawback that the introduced delay is random, and that the total unnecessary delay for both uplink and downlink could be as much as 40 milliseconds. This much delay degrades the audio quality significantly. Furthermore, if the delivery of the outbound speech frames happens to be very close to the last possible instant to allow for transmission in the subsequent radio frame, jitter in the delivery can result in arbitrary gaps in the speech, if late packets are dropped, or a 20 millisecond additional delay if late packets are kept.

In several embodiments of the present invention, a different approach is taken for coordinating audio data processing and network communication processing in cellular phones or other communication devices in which audio data is exchanged periodically over a communications link. This approach is particularly applicable to devices in which two physically separate circuits, e.g., an audio processing circuit and a modem circuit, are involved in the processing of the audio data, but the techniques described in detail below are not necessarily limited to such devices.

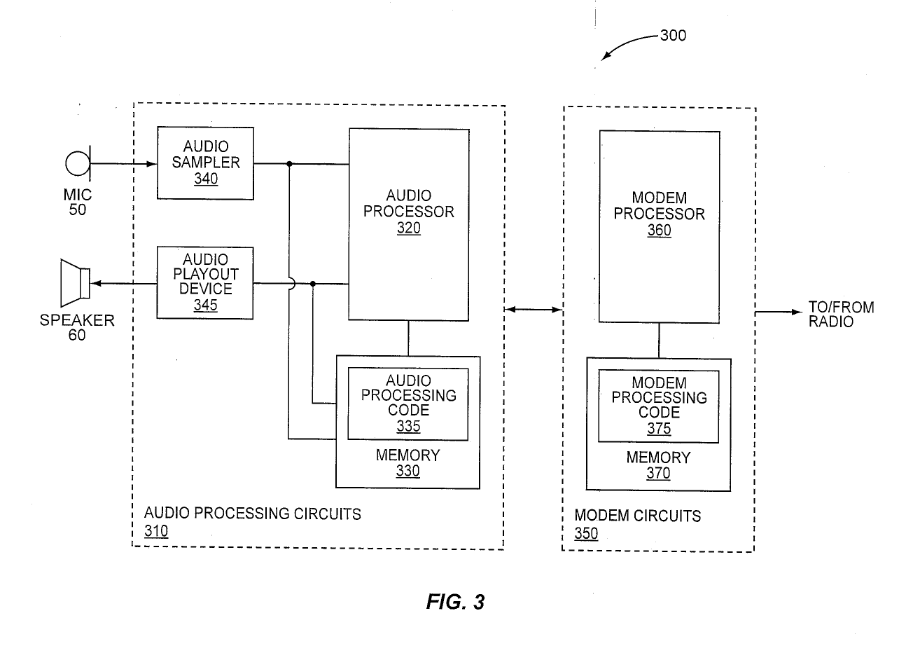

A block diagram illustrating functional elements of one such device is provided in FIG. 3, which shows a communication device 300 including an audio processing circuit 310 communicating with a modem circuit 350, via a bi-directional message bus. The audio processing circuit 310 includes an audio sampling device 340, coupled to microphone 50, and audio playout device 345 (e.g., a digital-to-analog converter) coupled to speaker 60, as well as an audio processor 320 and memory 330. Memory 330 stores audio processing code 335, which comprises program instructions for use by audio processor 320. Similarly, modem circuit 350 includes modem processor 360 and memory 370, with memory 370 storing modem processing code 375 for use by the modem processor 360. Either of audio processor 320 and modem processor 360 may comprise one or several microprocessors, microcontrollers, digital signal processors, or the like, configured to execute program code stored in the corresponding memory 330 or memory 370. Memory 330 and memory 370 in turn may each comprise one or several types of memory, including read-only memory, random-access memory, flash memory, magnetic or optical storage devices, or the like. In some embodiments, one or more physical memory units may be shared by audio processor 320 and modem processor 360, using memory sharing techniques that are well known to those of ordinary skill in the art. Similarly, one or more physical processing elements may be shared by both audio processing and modem processing functions, again using well-known techniques for running multiple processes on a single processor. Other embodiments may have physically separate processors and memories for each of the audio and modem processing functions, and thus may have a physical configuration that more closely matches the functional configuration suggested by FIG. 3.

As discussed in more detail below, certain aspects of the techniques described herein for coordinating audio data processing and network communication processing are implemented using control circuitry, such as one or more microprocessors or microcontrollers configured with appropriate firmware or software. This control circuitry is not pictured separately in the exemplary block diagram of FIG. 3 because, as will be readily understood by those familiar with such device's, the control circuitry may be implemented using audio processor 320 and memory 330, in some embodiments, or using modem processor 360 and memory 370, in other embodiments, or some combination of both in still other embodiments. In yet other embodiments, all or part of the control circuitry used to carry out the various techniques described herein may be distinct from both audio processing circuits 310 and modem circuits 350. Those knowledgeable in the design of audio and communications systems will appreciate the engineering tradeoffs involved in determining a particular configuration for the control circuitry in any particular embodiment, given the available resources.

In various embodiments of the present invention, a pair of threshold parameters (e.g., X_{low} and X_{high}) are used to represent an interval that controls whether a report is sent from the modem circuit 350 to the audio processing circuit 310. In these embodiments the timing report indicates, either explicitly or implicitly, that audio data supplied to the modem circuit 350 by the audio processing circuit 310 arrived outside of an interval defined by the thresholds and the radio frame timing. When the thresholds are appropriately configured, the timing report indicates that the audio data was received by the modem circuit 350 outside an optimal interval in relation to when the data is needed for further processing (e.g., Yₖ before the deadline for supplying data to the radio circuit for transmission over the air). The timing report can then be used by the audio processing circuit 310 to adjust the start of one or more audio processing functions, such as, for example, the sampling from a microphone, to minimize the delay during a speech call.

For audio data flowing in the other direction, i.e., from the modem circuit 350 to the audio processing circuit 310 for playout, the audio data for each frame is accompanied by an event report, in some embodiments, the event report indicating how much processing time that the modem circuit 350 has used in processing the current frame. In some embodiments, the event report further includes an indication of the maximum processing time that the modem circuit 350 could use, given the current configuration. In other embodiments, this maximum processing time may be provided separately. In either case, these two pieces of timing information permit the worst-case timing for subsequent frames to be accurately predicted. Thus, this timing information can be used by the audio processing circuit 310 to accurately determine an appropriate starting time for the playout of the audio data, such that a continuous audio signal can be sent to loudspeaker 60 without any gaps.

Following is a detailed explanation of exemplary processes and corresponding signal flows for coordinating audio data processing and network communication processing (e.g., modem processing) for each of the outbound and inbound signal flow directions. For convenience, the discussion below is provided in the context of a cellular phone, so that the inbound signal flow corresponds to the radio downlink and the outbound signal flow to the radio uplink, but the inventive techniques described are not limited to this context. The techniques illustrated in these exemplary procedures may be more generally applied to make it possible for an audio processing circuit in a communications transceiver to determine an appropriate start time for audio sampling and/or audio playout processes, so that delays in the end-to-end audio path are kept small while avoiding undesirable gaps or other discontinuities in the speech.

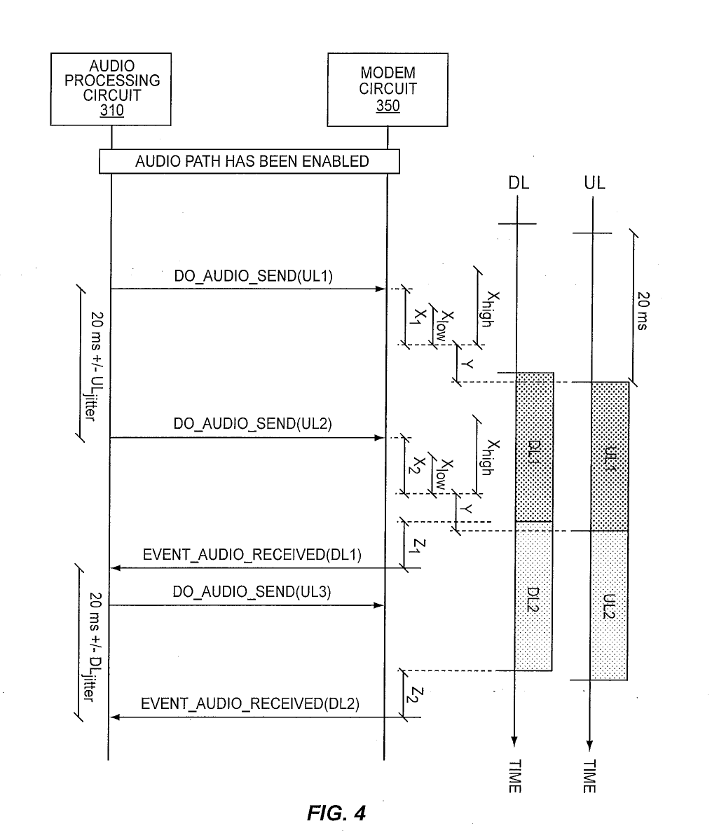

In the downlink audio path, received decoded audio frames are transferred from the modem circuit 350 to the audio processing circuit 310 as part of or accompanied by a event report message called “EVENT_AUDIO_RECEIVED.” Two of such events are illustrated in the bottom half of FIG. 4, which illustrates an exemplary signaling flow and the corresponding communication frame timing. These event reports are generally sent immediately after the modem processing is completed, but due to variable processing delay the exact timing of this event report, relative to the communication frame timing (on the right-hand side of FIG. 4), will jitter as described further below.

As can be seen in FIG. 4, the downlink jitter (DLⱼᵢₜₜₑᵣ) depends on the processing time Zₖ of the modem circuit 350, which may differ between every frame. Thus, as seen in FIG. 4, the timing between the first event report message, EVENT_AUDIO_RECEIVED (DL1), and the second event report message, EVENT_AUDIO_RECEIVED (DL2), depends on the modem processing times Z₁ and Z₂, for downlink frames DL1 and DL2, respectively. Thus, the interval between the first and second event reports is 20 milliseconds plus the difference between Z₂ and Z₁; this difference is the jitter.

A maximum value for the modem processing time Z can be defined as Zₘₐₓ. An indication of the value of Zₘₐₓ can be provided to the audio processing circuit 310 either at call set-up or as described below. In a GSM mobile device, Zₘₐₓ might be around 3 or 4 milliseconds, depending on the TDMA frame structure. In a WCDMA mobile, Zₘₐₓ might be closer to 10 milliseconds, depending on which transport channels are received simultaneously, and further depending on how the decoding scheduling is done. The processing time is, of course, also dependent on the processing capabilities for a given device, such as clock/processor/memory speeds, etc. When the receive processing of a downlink communications frame in modem circuit 350 is completed, a parameter is included as part of the event report EVENT_AUDIO_RECEIVED; this parameter indicates the current value of the decoding processing time Zₖ, i.e., the processing time corresponding to the current frame of encoded audio data. With this information (the current processing time Zₖ and the maximum processing time Zₘₐₓ), the audio processing circuit 310 can determine, after receipt of the very first audio frame, when the audio playout should be scheduled to start in order to get a continuous, low-delay, audio stream. As the speech call continues, the audio processing circuit 310 can use the timing information provided by subsequent event reports to determine whether a time drift has been introduced or a discontinuity in timing has occurred, and whether a further adjustment to the playout timing is necessary. This could happen, for example, if the modem circuit 350 and the audio processing circuit 310 use different clocks, if the modulation scheme changes, or if a handoff results in substantially different frame timing.

In some embodiments, changes in the value of Zₘₐₓ are indicated in the event report generated for a given frame. This might occur, for example, if the radio link technology or modulation scheme changes during the call. The audio processing circuit may use this revised value of Zₘₐₓ, along with the current value of Zₖ, to determine whether the timing of the outputting of the decoded audio should be adjusted. For example, if the maximum processing time Zₘₐₓ is 10 milliseconds, and the current processing time Zₖ received in the EVENT_AUDIO_RECEIVED message is 3 milliseconds, then the audio processing circuit 310 can readily compute that the maximum possible time until the next frame of encoded audio data will be received is 20+10−3=27 milliseconds. This information is used along with the maximum audio processing time (for decoding, etc.) to determine the optimal start time of the playout of the current audio frame. If the currently scheduled start time is too early or substantially too late, it can be adjusted to the appropriate time to prevent a situation in subsequent frames in which the playout buffer is starved (underflow) or in which unnecessary delay is introduced, respectively.

Another principle is applied to the signaling associated with uplink processing. Audio frames to be sent over the air by the modem circuit 350 are transferred from the application processing circuit 310 to the modem circuit 350 along with or as part of a message called “DO_AUDIO_SEND.” Two instances of this message are illustrated in the top half of FIG. 4. This is repeated every 20 milliseconds during a voice call, except when in discontinuous transmission (DTX) mode.

The uplink processing in the audio processing circuit 310 and modem circuit 350 may also jitter. If an encoded audio is provided to the modem circuit 350 too late, so that the modem processing is not completed in time to produce a communications frame to the radio circuitry in time for transmission, nothing will be sent to the network during the radio frame. (In some embodiments, the modem circuit 350 may be configured to send a pre-defined “silence frame” or other filler data, in the event that encoded audio is not supplied from audio processing circuit 310 in time.) Likewise, if the modem circuit receives more than one encoded audio frame before sending a corresponding communication frame to the network all frames except the last one might be discarded. (This is likely the case in the event that the radio link is a conventional circuit-switched voice channel. If the voice channel is instead provided via a circuit-switched-over-high-speed-data link instead, some frames might be resent in response to a transmission failure, thus resulting in the occasional sending of two or more data frames for a given voice frame interval.) The technique described below can prevent frames from being discarded, and can also allow for jitter in modem and audio processing, while at the same time keeping the delay as low as is practical.

In FIG. 4, several time values (Xᵢ, X_{low}, X_{high}, and Y) are illustrated in association with the transfers of encoded audio from the audio processor 310 to the modem circuit 350. These transfers are labeled DO_AUDIO_SEND (UL1) and DO_AUDIO_SEND (UL2), and contain encoded audio data intended for transmission in the uplink frames UL1 and UL2, respectively. The timing values Xₖ, X_{low}, X_{high}, and Y are used by the audio processing circuits 310 to optimize the timing of its sampling and encoding processes. In particular, X_{low} and X_{high} are upper and lower threshold values, respectively, which are configured by control circuitry in and/or associated with the audio processing circuit 310 and used by the modem circuit 350 to determine when the modem circuit 350 should generate an event report and send it to the audio processing circuit 130. In some embodiments, these are constant parameters configured at call set-up, although these parameters may be adjusted from time to time during a call in other embodiments.

The value Y is the processing time needed within modem circuit 350 to prepare the audio frame for transmission. This is a semi-static parameter that may depend, for example, on the current modulation and coding scheme, the number and types of parallel processes currently being handled by the modem circuit 350, etc. The value Xᵢ represents the time difference between when an audio frame is received by the modem circuit 350 and the processing deadline (i.e., the beginning of the interval labeled Y). Because of the jitter discussed above, this dynamic parameter can change from one audio frame to the next.

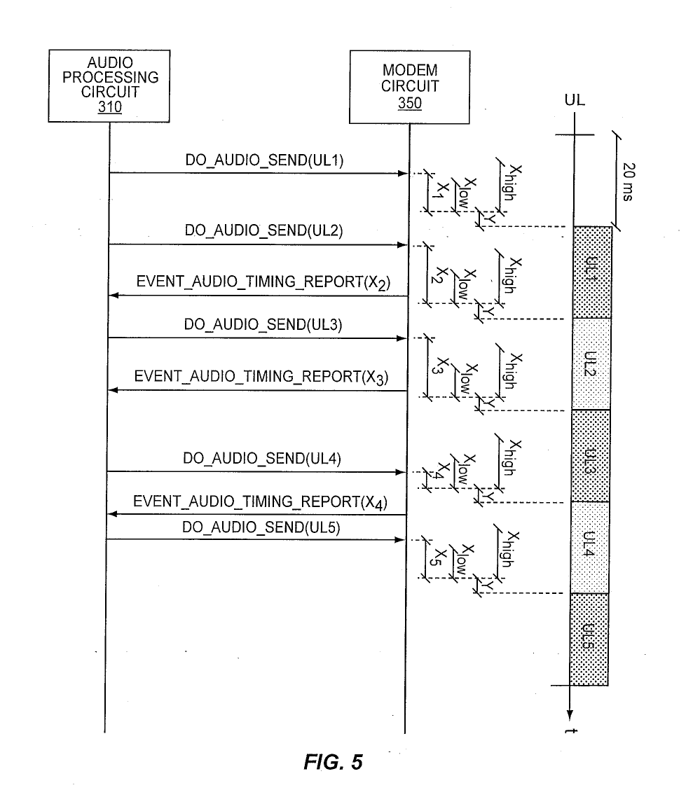

In some embodiments of the invention, an event report is triggered when an encoded audio frame is received by the modem circuit 350 outside of the timing window defined by the threshold values X_{low} and X_{high}. Several such events are illustrated in FIG. 5, where a message labeled EVENT_AUDIO_TIMING_REPORT (Xi) is introduced. This event report is used by the control circuitry in and/or associated with audio processing circuit 310 to control the timing of subsequent uplink audio frame encoding and the delivery of the encoded audio frames to the modem circuit 350.

As illustrated in FIG. 5, this report is sent from the modem circuit 350 to the control circuitry in and/or associated with audio processing circuit 310 in several distinct cases. First, the report is sent when the uplink audio frame supplied to the modem circuit 350 is received too early, i.e., more than X_{high} milliseconds before it is needed in modem circuit 350 for further processing. In FIG. 5, the delivery of audio data for each of uplink frames UL2 and UL3 are too early, thus triggering the generation of the event reports labeled EVENT_AUDIO_TIMING_REPORT (X2) and EVENT_AUDIO_TIMING_REPORT (X3). Second, the report is sent when the uplink audio frame supplied to the modem circuit 350 is received too late, i.e., less than X_{low} milliseconds before it is needed in modem circuit 350 for further processing. (X_{low} may be greater than zero to allow, for example, an early warning that the timing is close to the “deadline” for the processing time Y.) In FIG. 5, the delivery of audio data for uplink frame UL4 is too late, thus triggering the generation of the event report labeled EVENT_AUDIO_TIMING_REPORT (X4). Finally, an event report is triggered when modem circuit 350 discards an old, untransmitted frame when a new audio frame is received in time for modem processing; this event is not illustrated in FIG. 5.

In some embodiments, the parameters X_{low} and X_{high} are configured in run-time as part of the call set-up procedure, while in other embodiments these parameters may be statically configured. In some embodiments, the event report includes an explicit indication of the particular triggering event (e.g., audio frame received too late, too early, or extra frame received). For the events in which the encoded audio data was received too early or too late, an indication of how early or how late the data was received may also be provided. For instance, Xᵢ, the difference between the actual time the data was received and the last possible start of the modem processing interval Y, may be included in the event report. The resolution of the reported time Xᵢ may vary from one embodiment to the next, but in some embodiments may be on the order of 100 microseconds.

The event report and the timing information included therein are used by the control circuitry within or associated with audio processing circuit 310 to adjust the timing for sending subsequent encoded audio data frames to the modem circuit 350. In practice, this may comprise adjusting a sampling interval used for converting analog audio into sampled audio data and collecting the sampled audio data into frames, or adjusting the separation of sampled audio data into frames within an audio encoder, or both. In the signaling sequence illustrated in FIG. 5, the timing of the audio data delivery is ultimately adjusted properly for the delivery of data for uplink frame 5—because this delivery falls within the window defined by X_{low} and X_{high}, no event report is triggered.

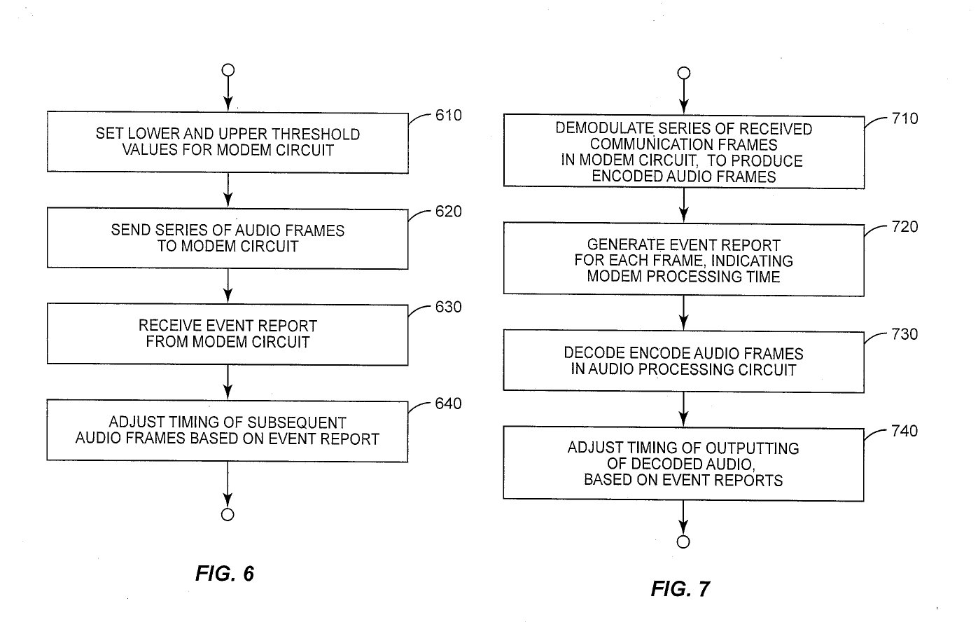

FIGS. 6 and 7 are processing flow diagrams illustrating exemplary methods for coordinating audio data processing and network communication processing for the outbound (e.g., uplink) speech path and inbound (e.g., downlink) speech paths, respectively, in a communication device. These methods may be implemented, for example, in the device 300 illustrated in FIG. 3.

FIG. 6 illustrates a process for outbound audio processing, such as for the uplink of a mobile phone. As shown at block 610, the process begins with the setting of lower and upper threshold values for use by a network communication processing circuit (e.g., the modem circuit 350 of FIG. 3), the lower and upper threshold values defining a window of timing offsets relative to each of a series of periodic network communications frame boundaries. In the case of a radio communication device like a cellular phone, these network communications frame boundaries comprise radio frame boundaries. In some embodiments, these upper and lower threshold values are established upon initializing the device, while in others the threshold values may be established at call set-up or even during a call, by sending the lower and upper threshold values to the network communication processing circuit.

Next, as shown at block 620, a series of encoded audio data frames are sent to the network communication processing circuit for transmission over the network communications link. Particularly when the method of FIG. 6 is performed at the initialization of a call, initial frame timing for the sampling and encoding processes may be arbitrarily or randomly established.

As discussed above, the delivery of encoded audio data to the network communication processing circuit outside of the time window defined by the threshold values will trigger an event report. This is received from the network communication processing circuit by the audio data processing circuit, as shown at block 630. In response to one or more of these event reports, control circuitry within and/or associated the audio data processing circuit adjusts the timing of the sending of one or more of the encoded audio data frames, based on the event report or reports, as shown at block 640. In some embodiments, this adjusting of timing comprises adjusting an audio sampling interval timing or an audio encoding interval timing, or both.

In some embodiments, the event report comprises an indication of whether the corresponding encoded audio frame was received early or late, relative to the window, or an indication of how early or how late the corresponding encoded audio frame was received, or both. In these and other embodiments, one or more event reports may indicate that an encoded audio frame was discarded by the network communication processing circuit and not transmitted.

A related technique for use in processing inbound speech data (e.g., the downlink in a mobile phone) is illustrated in FIG. 7. As shown at block 710, the illustrated process begins with demodulating a series of received communication frames, using a network communication processing circuit, to produce received encoded audio frames. An event report for each of one or more of the received encoded audio frames is generated, as shown at block 720, the event report indicating a network communication circuit processing time associated with the corresponding received encoded audio frames. The received encoded audio frames are decoded, using an audio data processing circuit, as shown at block 730, and the decoded audio is output to an audio circuit (e.g., a loudspeaker). Finally, the timing of the outputting of the decoded audio is adjusted, based on the generated event reports, as shown at block 740.

With these techniques synchronization between the audio processing timing and the network frame timing can be achieved, such that end-to-end delay is reduced and audio discontinuities are avoided. During call set-up the radio channels carrying the audio frames are normally established well before the call is fully connected. Thus, if the modem circuit 350 is configured so that no audio frames provided from the audio processing circuit 310 are actually transmitted until the call is fully connected, an optimal timing can be achieved from the start of the call.

As an example, assume that an audio processing circuit is configured to optimize the delay of a speech call using the techniques disclosed herein, and that the audio processing circuit has an internal jitter of around 0.3 milliseconds. Assume further that the audio processing circuit configures the modem circuit with high and low threshold values of X_{high}=1 and X_{low}=0.1, respectively (with each in units of milliseconds). At call set-up, when the audio path is initially established, the audio processing can simply pick an arbitrary starting time for the sampling/encoding processes. When the first encoded audio frames are transferred to the modem circuit, event reports are received indicating values of Xᵢ of about 7 milliseconds. These reports indicate that the audio frames are being supplied about 7 milliseconds earlier than the latest possible time. Thus, to decrease the end-to-end system delay, the audio processing circuit can adjust its sampling time. To target the center of the window defined by X_{low} and X_{high}, the audio processing circuit can adjust the frame timing associated with the sampling and/or encoding processes by about 6.4 milliseconds. The result will be that no more reports are received from the modem circuit until or unless the timing drifts, or unless some change in the system conditions causes a discontinuity in the communication frame timing.

As another example, assume that the same values as given in the previous example are used during a speech call, and no reports are being received from the modem circuit, indicating that that encoded audio frames are being received within the defined window. However, if another application running on the same communication device begins to download packet-switched data at a high rate, the load on the cellular modem subsystem or on the audio sub-system (or both) may be substantially increased, adding delay to the processing of the audio data. If, for example, processing time Y or processing time A (or their sum) is increased by 2 milliseconds, the audio data deliveries to the modem circuit will be late, resulting in event reports indicating values for Xᵢ of about 18 milliseconds. To reduce the end-to-end delay, the audio processing circuit may change (advance) the sampling and encoding time base by about 2 milliseconds, to get back to optimal timing again.

In the embodiments discussed above, event reports are sent only if audio data is delivered outside of the window defined by X_{low} and X_{high}. These embodiments may be configured to provide continuous reports, i.e., after each uplink audio frame is delivered to the modem circuit, by, e.g., setting the value of both X_{low} and X_{high} to zero. Similarly, if no reports are wanted, then the value for X_{low} may be set to zero, while the value for X_{high} is set to a value above 20 ms, such as 25 ms or 30 ms or more.

As suggested above, these techniques will handle the case where the modem circuit and audio processing circuits use different clocks, so that there is a constant drift between the two systems. Each time the drift gets two big, an event report is sent and the audio processing circuit can adjust. However, these techniques are useful for other reasons, even in embodiments where the modem and audio processing circuits share a common time reference. As discussed above, these techniques may be used to establish the initial timing for audio sampling and encoding, as well as audio decoding and playback, at call set-up. These same techniques can be used to readjust these timings in response to handovers, whether inter-system or intra-system (e.g., WCDMA timing re-initialized hard handoff). Further, these techniques may be used to adjust the synchronization between the audio processing and the modem processing in response to variability in processing loads and processing jitter caused by different types and numbers of processes sharing modem circuitry and/or audio processing circuitry.

Although the present inventive techniques are described in the context of a circuit-switched voice call, these techniques may also be adapted for other real-time multimedia use cases such as video telephony and packet-switched voice-over-IP. Indeed, given the above variations and examples in mind, those skilled in the art will appreciate that the preceding descriptions of various embodiments of methods and apparatus for coordinating audio data processing and network communication processing are given only for purposes of illustration and example. As suggested above, one or more of the specific processes discussed above, including the process flows illustrated in FIGS. 4 and 5, may be carried out in a cellular phone or other communications transceiver comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the processes described above, or variants thereof. In some embodiments, these processing circuits may comprise customized hardware to carry out one or more of the functions described above. Other embodiments of the invention may include computer-readable devices, such as a programmable flash memory, an optical or magnetic data storage device, or the like, encoded with computer program instructions which, when executed by an appropriate processing device, cause the processing device to carry out one or more of the techniques described herein for coordinating audio data processing and network communication processing. Those skilled in the art will recognize, of course, that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A method in a communication device for coordinating audio data processing and network communication processing, the method comprising:
setting lower and upper threshold values for use by a network communication processing circuit, the lower and upper threshold values defining a window of timing offsets relative to each of a series of periodic network communications frame boundaries;
sending each of a series of encoded audio data frames to the network communication processing circuit for transmission over a network communications link;
receiving an event report from the network communication processing circuit for one or more instances in which one of the encoded audio frames is sent to the network communication processing circuit outside any of the defined windows; and
adjusting timing of the sending of one or more of the encoded audio data frames based on the event report.

2. The method of claim 1, wherein adjusting timing of the sending of one or more of the encoded audio data frames comprises adjusting an audio sampling interval timing or an audio encoding interval timing, or both.

3. The method of claim 1, further comprising sending the lower and upper threshold values to the network communication processing circuit.

4. The method of claim 1, wherein the event report comprises at least one of (a) an indication of whether the corresponding encoded audio frame was received early or late, relative to the window, and (b) an indication of how early or how late the corresponding encoded audio frame was received.

5. The method of claim 1, wherein the event report indicates that an encoded audio frame was discarded by the network communication processing circuit and not transmitted.

6. The method of claim 1, further comprising randomly establishing an initial audio frame timing prior to sending the series of encoded audio data frames to the network communication processing circuit.

7. The method of claim 1, wherein the upper and lower threshold limits are set to the same value, so that an event report is received for each one of the encoded audio data frames.

8. A method in a communication device for coordinating audio data processing and network communication processing, the method comprising:
demodulating a series of received communication frames, using a network communication processing circuit, to produce received encoded audio frames;
generating an event report for each of one or more of the received encoded audio frames, the event report indicating a network communication circuit processing time associated with the corresponding received encoded audio frames;
decoding the received encoded audio frames using an audio data processing circuit, and outputting the decoded audio to an audio circuit; and
adjusting timing of the outputting of the decoded audio based on the generated event reports.

9. The method of claim 8, wherein the event report for each of the received encoded audio frames comprises encoded audio data for the corresponding frame.

10. The method of claim 8, wherein adjusting timing of the outputting of the decoded audio comprises determining, based on two or more generated event reports, that a timing drift has occurred, and adjusting the outputting of the decoded audio to compensate for all or part of the timing drift.

11. The method of claim 8, wherein said adjusting comprises calculating a start time for a frame of the decoded audio based on a frame duration, a maximum network communication circuit processing time, and a network communication circuit processing time corresponding to one or more of the received encoded audio frames.

12. The method of claim 8, wherein the event report for one or more of the received encoded audio frames further indicates a maximum network communication circuit processing time.

13. A communication device comprising a network communication processing circuit and an audio processing circuit, and comprising control circuitry configured to:
set lower and upper threshold values for use by the network communication processing circuit, the lower and upper threshold values defining a window of timing offsets relative to each of a series of periodic network communications frame boundaries;
send each of a series of encoded audio data frames to the network communication processing circuit for transmission over a network communications link;
receive an event report from the network communication processing circuit for one or more instances in which an encoded audio frame is sent to the network communication processing circuit outside any of the defined windows; and
adjust timing of the sending of one or more of the encoded audio data frames based on the event report.

14. The communication device of claim 13, wherein at least a portion of said control circuitry is integral to said audio processing circuit.

15. The communication device of claim 13, wherein at least a portion of said control circuitry is integral to said network communication processing circuit.

16. The communication device of claim 13, wherein the control circuitry is configured to adjust timing of the sending of one or more of the encoded audio data frames by adjusting an audio sampling interval timing or an audio encoding interval timing, or both.

17. The communication device of claim 13, wherein the control circuitry is further configured to send the lower and upper threshold values to the network communication processing circuit.

18. The communication device of claim 13, wherein the event report comprises at least one of (a) an indication of whether the corresponding encoded audio frame was received early or late, relative to the window, and (b) an indication of how early or how late the corresponding encoded audio frame was received.

19. The communication device of claim 13, wherein the event report indicates that an encoded audio frame was discarded by the network communication processing circuit and not transmitted.

20. The communication device of claim 13, wherein the control circuitry is further configured to randomly establish an initial audio frame timing prior to sending the series of encoded audio data frames to the network communication processing circuit.

21. The communication device of claim 13, wherein the upper and lower threshold limits are set to the same value, so that an event report is received for each one of the encoded audio data frames.

22. A communication device, comprising:
a network communication processing circuit configured to demodulate a series of received communication frames to produce received encoded audio frames and to generate an event report for each of one or more of the received encoded audio frames, the event report indicating a network communication circuit processing time associated with the corresponding received encoded audio frames; and
an audio data processing circuit configured to decode the received encoded audio frames and output the decoded audio to an audio circuit, and to adjust the timing of the output of the decoded audio based on the generated event report or event reports.

23. The communication device of claim 22, wherein the event report for each of the received encoded audio frames comprises encoded audio data for the corresponding frame.

24. The communication device of claim 22, wherein the audio data processing circuit is configured to adjust timing of the outputting of the decoded audio by determining, based on two or more generated event reports, that a timing drift has occurred, and adjusting the outputting of the decoded audio to compensate for all or part of the timing drift.

25. The communication device of claim 22, wherein the audio data processing circuit is configured to adjust timing of the outputting of the decoded audio by calculating a start time for a frame of the decoded audio based on a frame duration, a maximum network communication circuit processing time, and a network communication circuit processing time corresponding to one or more of the received encoded audio frames.

26. The communication device of claim 22, wherein the event report for one or more of the received encoded audio frames further indicates a maximum network communication circuit processing time.
